(19) United States
(12) Patent Application Publication
(10) Pub. No.: US 2018/0068381 A1
(43) Pub. Date: Mar. 8, 2018

(54) SYSTEM AND METHOD FOR AN ONLINE BUY-IN AUCTION SYSTEM

(71) Applicant: Janet Rush, Brooklyn, NY (US)

(72) Inventor: Janet Rush, Brooklyn, NY (US)

(21) Appl. No.: 15/698,170

(22) Filed: Sep. 7, 2017

Related U.S. Application Data
(60) Provisional application No. 62/384,422, filed on Sep. 7, 2016.

(51) Int. Cl. G06Q 30/08

(52) U.S. Cl. CPC G06Q 30/08

(57) ABSTRACT

The present disclosure is directed at a system and method for an online buy-in auction. The online buy-in auction system of the present disclosure enables users to “buy in” to online auctions for the opportunity to bid on items being sold on the online buy-in auction system. In one aspect of the present disclosure, the online buy-in auction system dynamically adjusts the buy-in prices based on one or more factors.

### PRIORITY

This application claims priority to U.S. Provisional Patent Application No. 62/384,422, filed on Sep. 7, 2016, entitled “SYSTEM AND METHOD FOR AN ONLINE BUY-IN AUCTION SYSTEM”, the contents of which are hereby incorporated by reference in its entirety.

### TECHNICAL FIELD

The present disclosure generally relates to online auction systems. More particularly, the present disclosure is related to a system and method for an online buy-in auction system.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

With the advance of the Internet, online commerce has expanded considerably. Specifically, online auctions have become an increasingly popular attraction for consumers seeking competitive prices for various items while making purchases online. However, many currently available online auction formats include prices for items that are too high to entice many buyers to participate and provide profit margins that are too low to entice sellers to list more items to be sold. Therefore, a need exists for online auctions that entice more buyers and sellers to participate in online auctions.

### SUMMARY

The present disclosure is directed at a system and method for an online buy-in auction system. The online buy-in auction system of the present disclosure enables users to “buy in” to online auctions for the opportunity to bid on items being sold on the online buy-in auction system. In one aspect of the present disclosure, the online buy-in auction system provides for a buy-in period, where users are enabled to submit buy-ins of a certain price or amount for an item being sold on the online buy-in auction system, and the online buy-in auction system determines if a predetermined amount of money is generated from the total buy-ins received for the item. If the online buy-in auction system determines that the predetermined amount of money is generated from the total buy-ins received for the item, the online buy-in auction system initiated an auction period where users who have submitted buy-ins are enabled to bid on the item in a live auction. In one aspect of the present disclosure, the online buy-in auction system dynamically and automatically adjusts the buy-in prices based on a plurality of factors.

In another aspect of the present disclosure, an apparatus is provided including: a communication module coupled to a network, the communication module configured to send and receive communications over the network; an auction module configured to host at least one online auction for at least one item, the at least one item having a predetermined item price; a buy-in module configured to: receive a plurality of buy-ins via the communication module, each buy-in associated with a user and being of a predetermined amount, determine a total amount by adding the plurality of buy-ins, determine if the total amount is equal to or greater than the predetermined item price, wherein if it is determined that the total amount is equal to or greater than the predetermined item price, the auction module is configured initiate an auction period for the at least one online auction; and a bid module configured to: enable each user having submitted a buy-in for the predetermined amount for the at least one online auction to submit at least one bid for the at least one item if the auction period is initiated, receive a plurality of bids via the communication module for the at least one item, determine a highest bid of the plurality of bids received, and determine a winner of the at least one auction, the winner having placed the highest bid within the auction period.

In another aspect of the present disclosure, the apparatus further includes: wherein, for each buy-in received after the auction period is initiated, the bid module is configured to reduce the predetermined amount.

In another aspect of the present disclosure, the apparatus further includes: wherein, each time the predetermined amount is reduced, the buy-in module is configured to refund each user having submitted a buy-in for the predetermined amount based on an amount the predetermined amount was reduced by.

In another aspect of the present disclosure, the apparatus further includes: wherein the buy-in module is configured to dynamically adjust the predetermined amount based on at least one factor.

In another aspect of the present disclosure, the apparatus further includes: wherein the at least one factor is a time elapsed from the last received buy-in.

In another aspect of the present disclosure, the apparatus further includes: wherein the at least one factor is a rate at which the plurality of buy-ins are being received.

In another aspect of the present disclosure, the apparatus further includes: wherein the at least one fact is whether the rate at which the plurality of buy-ins are being received is increasing or decreasing.

In another aspect of the present disclosure, the apparatus further includes: wherein the at least one factor is the amount of time left in the auction period.

In another aspect of the present disclosure, the apparatus further includes: further comprising a user account module configured to store proxy bidding rules for at least one user, wherein the bid module is configured to automatically enter at least one bid in the at least one auction during the auction period on the at least one user's behalf based on the proxy bidding rules stored in the user account module.

In another aspect of the present disclosure, the apparatus further includes: wherein the auction module is configured to transmit a notification via the communication module to each of the users having submitted a buy-in for the predetermined amount for the at least one online auction when the auction period is initiated, the notification indicative of the initiation of the auction period.

In another aspect of the present disclosure, a method is provided including: hosting, by an auction module, at least one online auction for at least one item, the at least one item having a predetermined item price; receiving, by a buy-in module, a plurality of buy-ins, each buy-in associated with a user and being of a predetermined amount; determining, by the buy-in module, a total amount by adding the plurality of buy-ins, and determining, by the buy-in module, if the total amount is equal to or greater than the predetermined item price, wherein if it is determined that the total amount is equal to or greater than the predetermined item price, the auction module is configured initiate an auction period for the at least one online auction, enabling, by a bid module, each user having submitted a buy-in for the predetermined amount for the at least one online auction to submit a bid for the at least one item if the auction period is initiated; receiving, by the bid module, a plurality of bids for the at least one item; determining, by the bid module, a highest bid of the plurality of bids received; and determining, by the bid module, a winner of the at least one auction, the winner having placed the highest bid within the auction period.

In another aspect of the present disclosure, the method further includes: reducing, by the buy-in module, the predetermined amount for each buy-in received after the auction period is initiated.

In another aspect of the present disclosure, the method further includes: refunding, by the buy-in module, each user having submitted a buy-in for the predetermined amount based on an amount the predetermined amount was reduce by each time the predetermined amount is lowered.

In another aspect of the present disclosure, the method further includes: dynamically adjusting, by the buy-in module, the predetermined amount based on at least one factor.

In another aspect of the present disclosure, the method further includes: wherein the at least one factor is a time elapsed from the last received buy-in.

In another aspect of the present disclosure, the method further includes: wherein the at least one factor is a rate at which the plurality of buy-ins are being received.

In another aspect of the present disclosure, the method further includes: wherein the at least one fact is whether the rate at which the plurality of buy-ins are being received is increasing or decreasing.

In another aspect of the present disclosure, the method further includes: wherein the at least one factor is the amount of time left in the auction period.

In another aspect of the present disclosure, the method further includes: automatically entering, by the bid module, at least one bid in the at least one auction on the at least one user's behalf based on proxy bidding rules associated with the at least one user and stored in a user account module.

In another aspect of the present disclosure, the method further includes: transmitting, via a communication module, a notification to each of the users having submitted a buy-in for the predetermined amount for the at least one online auction when the auction period is initiated, the notification indicative of the initiation of the auction period.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

FIG. 1 is an online buy-in auction system in accordance with an embodiment of the present disclosure.

FIG. 2 is an illustration of a user interface for the online buy-in auction system of FIG. 1 in accordance with an embodiment of the present disclosure.

FIG. 3 is an illustration of another user interface for an auction taking place on the online buy-in auction system of FIG. 1 in accordance with an embodiment of the present disclosure.

FIG. 4 is a flow chart of a method for conducting an online buy-in auction in accordance with an embodiment of the present disclosure.

It should be understood that the drawing(s) are for purposes of illustrating the concepts of the disclosure and is not necessarily the only possible configuration for illustrating the disclosure.

### DESCRIPTION OF EMBODIMENTS

It also should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure is directed at a system and method for an online buy-in auction system. The online buy-in auction system of the present disclosure enables users to “buy in” to online auctions for the opportunity to bid on items being sold on the online buy-in auction system. In one aspect of the present disclosure, the online buy-in auction system provides for a buy-in period, where users are enabled to submit buy-ins of a certain price or amount for an item being sold on the online buy-in auction system, and the online buy-in auction system determines if a predetermined amount of money is generated from the total buy-ins received for the item. If the online buy-in auction system determines that the predetermined amount of money is generated from the total buy-ins received for the item, the online buy-in auction system initiates an auction period where users who have submitted buy-ins are enabled to bid on the item in an online auction. In one aspect of the present disclosure, the online buy-in auction system dynamically and automatically adjusts the buy-in prices based on one or more factors.

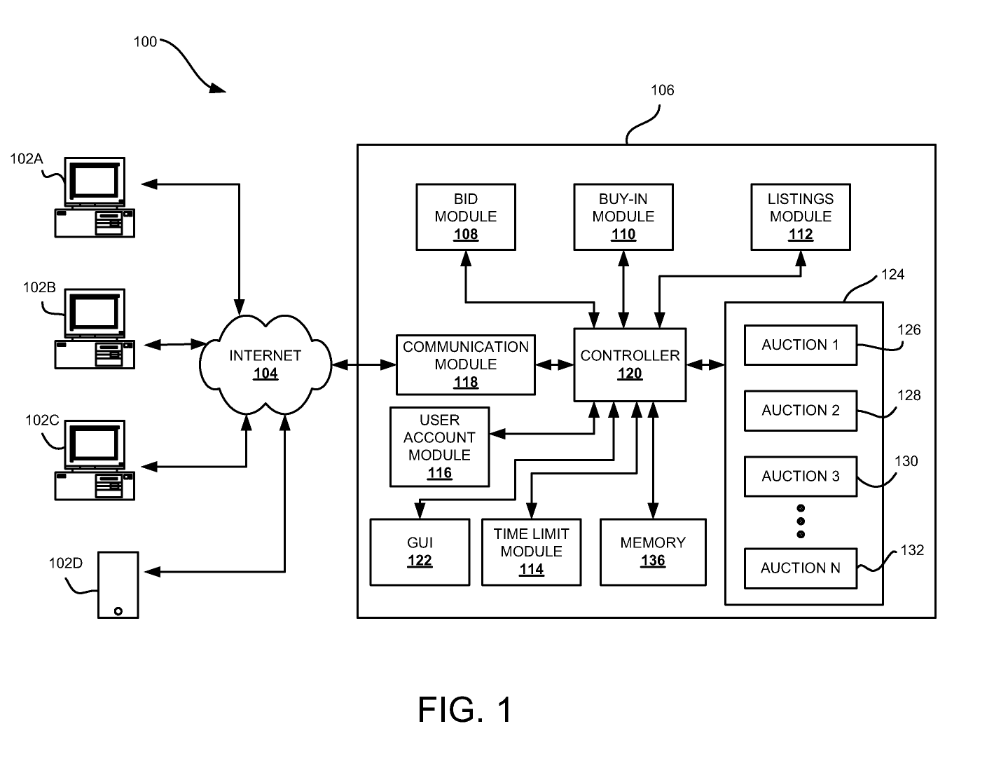

Turning now to the drawings and referring initially to FIG. 1, an online buy-in auction system 100 is shown in accordance with an embodiment of the present disclosure. System 100 includes user computing devices 102A, B, C, and D that are coupled to online buy-in auction server 106 via a network 104. It is to be appreciated that network 104 may be a network, such as the Internet, or any other suitable wired and/or wireless telecommunications network that enables user computing devices 102A-D to communicate with online buy-in server 106. It is also to be appreciated that user computing device 102 may be a personal computer, such as user computing devices 102A-C, a smart phone or tablet, such as user computing device 102D, or any other suitable computing device that has suitable display and processing capabilities and can be connected to a telecommunications network.

Online buy-in auction server 106 includes bid module 108, buy-in module 110, listings module 112, time limit module 114, user account module 116, communication module 118, controller 120, graphical user interface (GUI) 122, and auction module 124. As seen in FIG. 1, controller 120 is coupled to each of bid module 108, buy-in module 110, listings module 112, time limit module 114, user account module 116, communication module 118, GUI 122, and auction module 124. It is to be appreciated that the online buy-in auction server 106 of the present disclosure may be implemented in hardware, software, firmware, or any combinations thereof. In some embodiments, the online buy-in auction server 106 may be implemented in software or firmware that is stored on a memory device (e.g., a memory device) and that is executable by a suitable instruction execution system (e.g., a processing device). In some embodiments, the various modules (e.g., modules 108, 110, 112, 114, 116, 118, 120, 122, 124, 136) may be implemented individually and/or collectively in hardware using, for example, discrete logic circuitry, an application specific integrated circuit (ASIC), a programmable gate array (PGA), a field programmable gate array (FPGA), or any combinations thereof.

Each user computing device 102 is configured to transmit and receive communication signals carrying data to and from online buy-in auction server 106 via network 104 to enable a user to participate in one or more auctions 126, 128, 130, 132 hosted on online buy-in auction server 106 from their computing device 102 or to sell one or more items via auction on server 106. Communication module 118 in online buy-in auction server 106 is configured to transmit and receive communications signals carrying data to and from user computing devices 102. Any data received by communication module 118 from network 104 is transmitted to controller 120 and any data received by communication module 118 from controller 120 is transmitted to the intended computing device 104.

It is to be appreciated that controller 120 includes a processor capable of executing instructions stored in controller 120 and/or memory 136. Controller 120 is also configured to control other components in online buy-in auction server 106. It is also to be appreciated that in some embodiments controller 120 may contain more than one processor. It is to be appreciated that any of components 108, 110, 112, 114, 116, 118, 120, 122, 124 may be a separate processing device. Alternatively, one or more of components 108, 110, 112, 114, 116, 118, 120, 122, 124 may be implemented in a single processing device.

Users using a computing device 102 may make a user account that is stored in user account module 116 to participate in auctions that are hosted in auction module 124 and/or offer items to be sold on server 106. It is to be appreciated that a wide variety of user related information may be stored in user account module 116, such as, but not limited to, the user's real name, the user's username (i.e., the name chosen by the user to participate in the online auctions), the user's email, user's payment information (i.e., bank account, paypal, debit/credit cards, etc.) for purchasing account credit, paying for bids and/or being paid for items sold on server 106, account balance (i.e., amount of account credit available for use on the online buy-in auction server 106), user purchase history, and user account settings (i.e., proxy bidding rules set by the user, as will be described below).

Users intending to sell items on server 106 may transmit information associated with one or more items to server 106 via a computing device 102. The information associated with each of the items being sold on online buy-in auction server 106 are stored in listings module 112. It is to be appreciated that listings module 112 stores a wide variety of information associated with each item to be sold on online buy-in auction server 106. For example, in one embodiment, the listings module may store information such as, but not limited to, the item name, graphics for displaying the item (i.e., pictures and/or videos of the item), a description of the item, the price the seller wishes to sell the item for, rules associated with the auction of the item, and other information to be described below. The information relating to each item is used by auction module 124 to generated and host a plurality of auctions 126, 128, 130, 132.

In one embodiment, for each auction generated and hosted by auction module 124, auction module 124 is configured to initiate a first period or mode (e.g., a “buy in” period). During the buy in period, users may preview information relating to an item (e.g., graphics, descriptions, etc.) being offered for sale by a user on server 106. If the user is interested in participating in the auction for the item, the user is required to “buy in” for a predetermined buy-in price or amount (set by the seller). To buy in to an auction, a user transmits a buy-in signal via a computing device 102 to server 106. The buy-in signal is received by buy-in module 110 via communication module 118, where buy-in module 110 is configured to access payment or account credit information that is stored in user account module 116 to pay for a user's buy-in.

During the buy in period, the auctioning process (i.e., bidding) for the item has not begun. Instead, buy-in module 108 is configured to add all of the buy-ins received from users wishing to participate in the auction for the item to determine a cumulative total amount of money generated from all of the buy-ins received. If the total amount of money generated by the buy-ins received for an item is equal to, or has exceeded, a predetermined item price (set by the seller), auction module 124 is configured to trigger a second period or mode (e.g., an “auction” period), where the auctioning process for the item may begin. In this way, an online auction for an item can only occur if the seller has already been guaranteed to receive the predetermined item price (via the total number of buy-ins received) for the item.

During the auction period, users having bought into the auction (i.e., by transmitting a buy-in signal for the buy-in amount to buy-in module 110) are permitted to bid on the auction item. It is to be appreciated that once an auction period has been initiated for an item, the user buy-ins received for the item being auctioned are non-refundable. To bid on the auction item, a user may send a bid signal associated to a bid amount from a user computing device 102 to server 106 via Internet 104. The bid signal is received by communication module 118 and sent to bid module 108. Bid module 108 is then configured to enter a bid amount associated to the bid signal on the user's behalf in the auction hosted by auction module 124. It is to be appreciated that during the auction period when the auction for the item is occurring, additional users that have not already bought into the auction are also allowed to buy in. Furthermore, it is to be appreciated that the length of the duration auction period may be selectable by the seller. At the end of the auction period, bid module 108 is configured to determine the which user submitted the highest bid to declare a winner. In addition to the buy-in price paid, the auction winner will also be required to pay the winning bid price. The users in the auction who did not submit the highest bid by the end of the auction period, are only required to pay the buy-in price.

In some embodiments, when an auction period is triggered, auction module 124 is configured to transmit a notification signal via communication module 118 to each user having bought into the auction to inform the user that an auction for the item has begun and open bidding for the item is now available.

In some embodiments, when a user submits a buy-in for an item during the buy-in period, the user is also required to submit an initial bid that is received and stored by bid module 108. The initial bid is not submitted into the auction during the buy-in period (i.e., there is still no bid price for the item). Instead, if an auction period is later triggered by auction module 124 for the item, the initial bid of each user is automatically entered on each user's behalf by bid module 108 in the auction for the item. Bid module 108 then determines the highest initial bid, to determine the initial bid price for the auction item. In some embodiments, bid module 108 or auction module 124 may automatically transmit notifications to each user that has bought into an auction to inform them if they have submitted to highest initial bid or if another user has submitted the highest initial bid.

After the auction period has been initiated by auction module 124, open bidding for the item being auctioned is allowed, where each user may bid on the item being auctioned. In some embodiments, auction module 124 may be configured to require each user to submit a separate buy-in for each bid placed on the item. In other embodiments, each buy-in may entitle the user to a predetermined number of bids (2, 5, 10, etc.).

It is to be appreciated that in some embodiments, the buy-in or preview period may be indefinite. In other embodiments, the buy-in period may be a predetermined time (e.g., 1 hour, 1 day, 10 days, etc.) period chosen by the seller of the item. In this embodiment, if buy-in module 110 determines that the buy-in period has ended for an item without having received enough buy-ins such that the total number of buy-ins is equal to or greater than the predetermined item price, each of the user's having submitted buy-ins for an item will be refunded for the buy-in amounts each user submitted and the auction will be terminated.

As an example of a buy-in auction provided on server 106, in one embodiment, auction module 124 may generate and host an auction 126 for an item listed by a seller in listings module 112, such as a smart TV. Auction module 124 is configured to provide for a buy-in period for auction 126. It is to be appreciated that the length of time for the buy-in period for auction 126 is selectable by the seller. The buy-in price or amount to buy in to auction 126 may be $10, where the buy-in price is selectable by the user. A user desiring to participate in auction 126 is required to first pay the buy-in price corresponding to the item for the user to gain the privilege to bid on the item if an auction period is later initiated. In this example, the user would pay $10 to buy in to auction 126 (e.g., by transmitting a buy-in signal indicative of the $10 buy-in to buy-in module 112).

After each buy-in for auction 126 is received by buy-in module 110 during the buy-in period, buy-in module 110 is configured to determine if the money generated from the total number of buy-ins received for auction 126 is equal to or has exceeded the predetermined item price chosen by the seller. For example, in this example, the predetermined item price for the smart TV may have been set at $300 by the seller. If buy-in module 110 determines that the total number of buy-ins received is equal to or has exceeded $300 (e.g., 30 or more buy-ins have been received), auction module 124 is configured to initiate an auction period for auction 126. Once the auction period for auction 126 has been initiated, each of the users having submitted the buy-in amount (e.g., $10) for the item being auctioned in auction 126 are permitted to submit bids in auction 126. Bid module 108 will determine the user having submitted the highest bid before the end of the auction period to determine the winner of the auction. As described above, during the auction period for auction 126, additional users who have not already submitted a buy-in for the auction may also buy-in.

As an example, the bidding for auction 126 may initially begin at $0.05. By the end of the auction period, after a plurality of bids have been received via bid module 108, the winning bid may be $10.50. Bid module 108 is configured to determine the user having submitted the winning bid and will deduct the winning bid amount ($10.50) from the user's account in user account module 116. As stated above, after the auction period is initiated, the buy-ins received from each user are non-refundable. Therefore, after the auction period is initiated, buy-in module 110 is configured to deduct the buy-in amount ($10) from each user's account in user account module 116 for user's having bought into the auction. At the end of the auction period for auction 126, the sellers account may be credited with the total money generated by the buy-ins received (e.g., $10 multiplied by the number of buy-ins received) in addition to the winning bid (e.g., $10.50). It is to be appreciated that a portion of the money credited to the seller from an auction may be withheld and retained by online auction server 106 as a fee for providing the online selling service.

As the above described example shows, even before the auction period for auction 126 has been initiated, the seller has already been guaranteed to generate enough money to pay for the predetermined item price chosen by the seller. In this way, the seller is guaranteed to make the desired amount of money for selling the item on server 106 regardless of the results of the bidding process during the auction period.

In some embodiments, a seller may choose to have a price-capped auction. It is to be appreciated that the style of auction the seller chooses to have for a specific item is saved in listings module 112. In a price-capped auction, when buy-in module 110 determines that the sum of the received buy-ins equals the predetermined item price (e.g., $300 in the example above) of the specific item, for each additional buy-in received after the predetermined item price has been reached, buy-in module 110 will decrease the buy-in amount that is required by all participants that have already paid the buy-in to participate in an auction and any future participants that wish to do so. Furthermore, in this embodiment, each subsequent buy-in received by buy-in module 110 will continue to lower the buy-in price (e.g., by a fixed or dynamically adjusted amount, as will be described in greater detail below).

For example, continuing with the scenario described above, the smart TV in auction 126 may have predetermined item price of $300 and a buy-in price of $10. After buy-in module 110 receives 30 buy-ins of $10 (i.e., $300), buy-in module 110 will determine that the predetermined item price of the item being sold (i.e., the smart TV in this scenario) has been reached and the auction period will be initiated by auction module 124. When buy-in module 110 receives the 31^{st} buy-in, buy-in module 110 will automatically lower the required buy-in price for auction 126 by an amount determined by buy-in module 110 based on the auction settings stored in listings module 112 for the specific item (i.e., the smart TV).

It is to be appreciated that the buy-in price for an auction 126 may be lowered by buy-in module 110 automatically based on one or more factors, as will be described below.

In one embodiment, buy-in module 110 may be configured to lower the buy-in price to bid on a specific item by a predetermined fixed amount (chosen by the seller and saved in the settings for the item in listings module 112) for items where the price-cap has been exceeded by the cumulative total of the received buy-ins. For example, continuing with the scenario described above, after buy-in module 110 receives the 31^{st} buy-in, all buy-in's (i.e., for all 31 users participating in the auction 126 for the smart TV) may be lowered by the predetermined amount, e.g., $0.05. Therefore, the buy-in for 31 users will become $9.95 and each users account (stored in module 116) will be credited with the difference (i.e., $0.05, in this scenario) between the originally paid buy-in price and the new, lowered buy-in price. When the 32^{nd} buy-in is received, buy-in module 110 will lower buy-in for all 32 users to $9.90 and again credit each user account with $0.05.

In another embodiment, buy-in module 110 may be configured to automatically and dynamically lower the buy-in price to bid on a specific item based on one or more factors. For example, in one embodiment, the buy-in module 110 is configured to monitor the time period that has elapsed since the last buy-in was received for a specific item. If the time period measured by buy-in module 110 since the last buy-in was received is above a predetermined time period, buy-in module 110 may lower the buy-in by a first predetermined amount (e.g., $0.10) and if the time period measured by buy-in module 110 since the last buy-in was received is below the predetermined time period (i.e., buy-ins are being received in a shorter time frame), buy-in module 110 may lower the buy-in by a second predetermined amount. In one embodiment, the first predetermined amount may be greater than the second predetermined amount to entice more users to buy-in to a specific auction (since the buy-in amount is decreasing by a more significant amount). In some embodiments, the predetermined time period may be based on an average time period elapsed between the received buy-ins (e.g., if 10 buy-ins have been received in 5 minutes, the average time period elapsed between buy-ins is 30 seconds).

In another exemplary embodiment, buy-in module 110 is configured to monitor the rate at which buy-ins are being received on a particular item and can lower the buy-in amount based on whether the rate at which the buy-ins are being received is increasing or decreasing.

For example, if the rate at which buy-ins are being received for an item is increasing (e.g., the subsequent time elapsed between received buy-ins is decreasing), buy-in module 110 may lower the buy-in price for that specific item by a first predetermined amount. If the rate at which buy-ins are being received for an item is decreasing (i.e., the subsequent time elapsed between received buy-ins is increasing), buy-in module 110 may lower the buy-in price for that specific item by a second predetermined amount. In one embodiment, the first predetermined amount is lower than the second predetermined amount. In this way, if buy-in module 110 determines that interest for an item is slowing down based on the rate at which buy-ins are being received decreasing, buy-in module 110 can lower the buy-in price by larger amounts to entice more users to buy-in to an auction. Alternatively, if buy-in module 110 determines interest for an item is increasing based on the rate at which buy-ins are being received increasing, buy-in module 110 can lower the buy-in price by lower amounts, since the interest in the item is already high. In some embodiments, if buy-in module 110 determines that the rate at which buy-ins are being received is relatively unchanged, buy-in module 110 may maintain the buy-in price at the current amount.

Buy-in module 110 may determine if the rate at which buy-ins are being received is increasing or decreasing by comparing the rate at which predetermined previous number of buy-in have been received to the rate at which the total number of buy-ins have been received. For example, if 100 total buy-ins (from either the start of the buy-in period or the start of the auction period) have been received in 10 minutes, the rate at which the total number of buy-ins have been received is 10 buy-ins/minute. If the previous 20 buy-ins have been received in the last 1 minute (measured relative to the current time), the rate at which the previous 20 buy-ins have been received is 20 buy-ins/minute. By comparing the rate at which the previous 20 buy-ins have been received to the rate at which the total number of buy-ins have been received, buy-in module 110 is able to determine that the rate at which buy-ins are being received is increasing (e.g., in the previous minute the rate is 20 buy-ins/minute, compared to the rate of 10 buy-ins/minute that the total number of buy-ins were received in).

It is to be appreciated the buy-in module 110 may be configured to dynamically adjust the buy-in price based on many other factors. For example, in one embodiment, the buy-in module 110 may lower the buy-in price based on how much time is left in either the buy-in period or the auction period for a given auction. In another embodiment, buy-in module 110 may lower the buy-in amount based on a ratio between the predetermine item price of the item (described above) and the price of the highest bid on the item.

In each of the factors described above for dynamically adjusting the buy-in price, the buy-in price may be dynamically adjusted by buy-in module 110 during the buy-in period and/or the auction period.

In another embodiment, a seller may choose to have a capless auction. In this embodiment, the buy-in amount is not lowered and remains constant throughout the auction. It is to be appreciated that the choice to have a capless auction may be chosen by a seller and saved in listings module 112.

It is to be appreciated that time limit module 114 is configured to maintain and monitor all time limits (e.g., buy-in periods and auction periods) for all of the auctions hosted by auction module 124.

In one embodiment, the amount a user is allowed to bid (for each separate bid) is determined by the user (i.e., the user may choose the bid size). In another embodiment, the amount the user is allowed to bid is fixed, where the fixed amount is stored in the settings for the specific item in listings module 110.

In some embodiments, the buy-in submitted by each user during the buy-in period entitles each user having bought into the auction to submit unlimited number of bids during the auction period. In some embodiments, the bid increments are fixed at a predetermined price (e.g., $0.01, $0.05, etc.) or to be within a predetermined range ($0.01-$0.05, $0.01-$0.02, etc.).

In one embodiment, the duration of the buy-in period and/or auction period may be fixed and predetermined (e.g., chosen by the seller and saved in listings module 110). The buy-in period may begin automatically when the auction item is posted for auction in auction module 124. Alternatively, in another embodiment, the buy-in period may automatically begin when the first buy-in is received and the auction period may automatically begin when the predetermined item price an item is reached by the total received buy-ins for the item. It is to be appreciated that time limit module 114 is configured to automatically check the type and length of the time limit chosen to be employed for an item being sold in listings module 110 to apply the time limit in each auction.

In another embodiment, the duration of the auction period may be determined automatically and dynamically by time-limit module 114 based on one or more factors. For example, in one embodiment, time limit module 114 is configured to determine the amount of time it took (measured from the reception of the first buy-in) for the total amount of money generated from the buy-ins received to reach or exceed the predetermined item price. Based on this determination, bid module 108 and/or auction module 124 is configured to automatically and dynamically determine duration of the auction period to be employed in the auction of an item. It is to be appreciated that other factors may be used as well to automatically and dynamically determine the duration of the auction period, such as, but not limited to, the time elapsed between received buy-ins and the rate at which buy-ins have been received.

It is to be appreciated that one or more factors may also be used to determine the duration of the buy-in and/or auction periods, such as, but not limited to, the type of item being sold (e.g., categories of goods may have predetermined buy-in and or auction times associated with each category that may be stored in memory 136 and used to determine the buy-in and/or auction periods), and/or the predetermined item price chosen by the seller (expensive items may receive longer buy-in and/or auction periods than less expensive items).

It is to be appreciated that a user may choose to have bid module 108 enter bids on an auction item automatically on the user's behalf based on one or more proxy bidding options saved by the user in user account module 116. For example, a user may buy-in to an auction hosted by auction module 124, such as auction 126. After the user buys in, the user may choose, in user account module 116, to have bids automatically be entered by bid module 110 if an auction period is initiated based on the user's chosen proxy bidding rules. For example, the user may choose to have bid module 110 enter bids on behalf of the user for an item whenever the user is not winning in fixed bid increments up to a predetermined bid amount. As an exemplary case, continuing with the smart TV described above, the user may choose, in user account module 116, to have bid module 108 place bids in predetermined increments (e.g., $0.05) up to a certain predetermined capped amount (e.g., increasing the bid until the cap of $40 is reached) whenever bid module 108 determines that the user is not currently the highest bid for the smart TV. For example, if the highest bid is $20 on the smart TV, and the user is not the highest bid, bid module 108 is configured to enter a bid on the user's behalf for $20.05. If other users keep outbidding the user, bid module 108 will keep entering higher bids (in increments chosen by the user) until the user's bid cap amount is reached (i.e., until the highest bid exceeds $40 in this scenario).

In another embodiment, bid module 108, buy-in module 110, listings module 112, and/or time limit module 114 may be configured to send a user notification to his/her computing device 102, based on stored user settings in user account module 116. For example, in one embodiment, the user may choose to have notifications sent to the user by bid module 108, when an auction period for an auction the user has bought into is initiated or when a user has been outbid by another user on a certain item after the auction period has been initiated. In another embodiment, the user may choose to have notifications sent to the user by buy-in module 110 when the buy-in on a certain item falls below a certain amount (either during the buy-in period or the auction period) chosen by the user. In another embodiment, the user may choose to have notifications sent to the user by listings module 112 when a particular type of item is listed for auction. For example, the user may choose to have notifications sent to the user's computing device when a specific type of smart TV is listed in listings module 112. In this embodiment, listings module 112 is configured to search listings module 112 at predetermined time intervals that match the item the user is interested in. In another embodiment, the user may choose to have notifications sent to the user by time limit module 114 when there is less than a predetermined time amount left in the auction period for a particular item.

GUI 122 is configured to generate a graphical user interfaces configured to enable a user to interact with server 106 via a user's computing device 102. GUI 122 is configured to receive information from bid module 108, buy-in module 110, listings module 112, time-limit module 114, user account module 116, and auction module 124 via controller 120. Information received by GUI 122 is then processed and a graphical user interface (e.g., a webpage or mobile application) is generated by GUI 122. The graphical user interface may then be transmitted to communication module 118 via controller 120. Once received by communication module 118, the graphical user interface can be transmitted to a user computing device 102 and shown on a display on a user computing device 102.

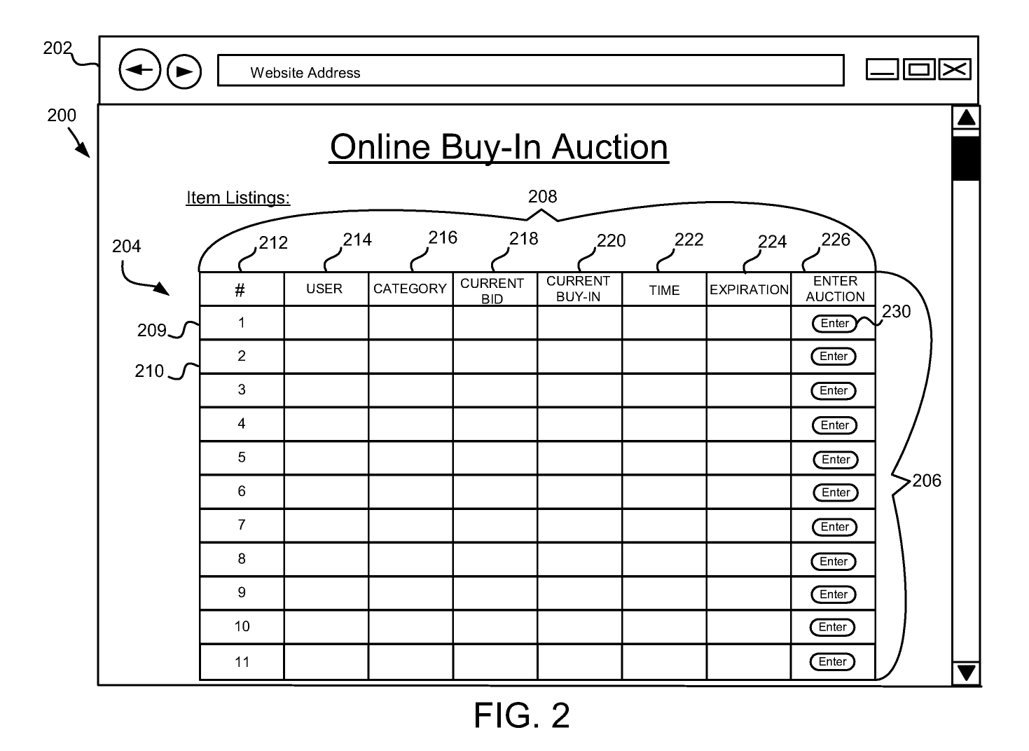

Turning now to FIG. 2, an exemplary graphical user interface (“GUI”) 200 of items listed in an online buy-in auction is shown in accordance with an embodiment of the present disclosure. It is to be appreciated that GUI 200 may be generated in GUI module 122 and accessed via communication module 118 and network 104 to be displayed on a user computing device 102. GUI 200 may be displayed on a browser 202 on a user computing device 102. It is to be appreciated that browser 202 may be a mobile browser for a mobile computing device, such as a smartphone or tablet, or browser 202 may be desktop browser for a personal computer or laptop. It is to be appreciated that, in another embodiment, GUI 200 may be displayed in a desktop or mobile application specifically created for the online buy-in auction system of the present disclosure.

GUI 200 includes table 204, where table 204 contains a plurality of rows 206 and columns 208. Columns 208 contain various information associated with auctions being hosted by auction module 124, and each row in rows 206 corresponds to a specific auction for an item (e.g., row 209 corresponds to auction 1 for item 1, row 210 corresponds to auction 2 for item 2, etc.). For example, columns 208 may include a column 212 to indicate the number of different auctions being hosted by auction module 124. Columns 208 may also include columns associated with auction-related information, such as, but not limited to column 214, which includes a user's user name who is selling the item for auction, column 216, which includes the category of product beings sold (e.g., clothes, shoes, electronics, books, etc.), column 218, which includes the current highest bid on the item, column 220, which includes the current buy-in price to bid in the item, column 222, which includes the time the item was posted for auction, column 224, which includes the expiration time of the auction (i.e., the time left in the buy-in period or the auction period), and column 226 which includes a plurality of buttons 230. It is to be appreciated that each row 206 may correspond to an auction that is in either the buy-in period or the auction period.

It is be appreciated that above described information is merely a small subset of the possible types of information that can be included in table 204 and that in other embodiments more columns may be added to table 204 to accommodate additional types of information. Furthermore, it is to be appreciated that GUI module 122 pools information from bid module 108, buy-in module 110, listings module 112, time-limit module 114, user account module 116, and auction module 124 via controller 120 at frequent, predetermined intervals to update table 204.

Each row in column 226 includes a button 230 that is selectable by the user on the user's computing device 102. When a user selects button 230, a signal indicative of the user's selection is transmitted from the user's computing device 102 via Internet 104 and communication module 118 to GUI 122. Upon receipt of the signal indicative of a selection of button 230, GUI 122 is configured to generate a GUI for the auction corresponding to the row the selected button 230 is in. The generated GUI for the auction is then provided to the user's computing device 102. For example, if the user selects the button 230 in the row 208, GUI 122 is configured to generate and provide a GUI for the auction item corresponding to the first row to the user's computing device 102.

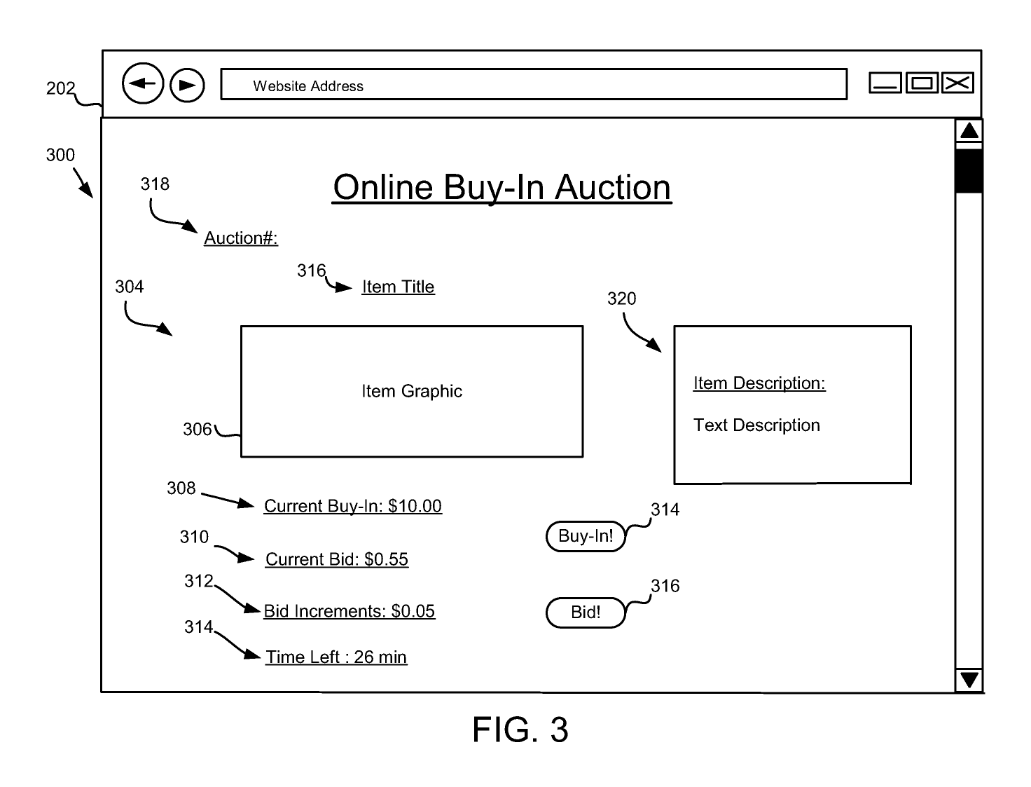

For example, referring to FIG. 3, an exemplary GUI 300 for an auction being hosted on server 106 is shown in accordance with an embodiment of the present disclosure. It is to be appreciated that GUI 300 may be generated in GUI module 122 and accessed via communication module 118 and network 104 to be displayed on a user computing device 102 after button 230 is pressed by a user.

As shown in FIG. 3, GUI 300 includes information related to an auction 304 (hosted by auction module 124) for one of the items stored in listings module 112 and shown in table 204.

In one embodiment, the GUI 300 may include information related to the item listed for auction 304. For example, GUI 300, shown in FIG. 3, includes the auction number (i.e., the number in column 212 of GUI 200) 318, an item title 316 (i.e., the title of the item or product being auctioned), an item graphic 306 (i.e., pictures or videos associated with the item being auctioned), and an item description 320 that may include text describing the item being auctioned. It is to be appreciated that the above described information is stored in listings module 110.

It is to be appreciated the GUI 300 may also include information relating to the current auction 304 and means to participate in the auction 304. For example, GUI 300 also includes a current buy-in price 308, a current bid price 310, the bid increments 312 (if applicable for the given auction), and the time left (e.g., buy-in period or auction period) in the auction 314. Auction 304 also includes buy-in button 314 and bid button 316, where buttons 314 and 316 are configured to be selectable by a user using a computing device 102 to enable the user to participate in the auction. It is to be appreciated that if an auction is presently in a buy-in period, current buy-in price 208, current bid price 310, bid increments 312, and/or button 316 may not be included or populated with information or may not be selectable by the user until/unless an auction period for a given auction is initiated.

When the user selects buy-in button 314, a signal indicative of a buy-in request for the buy-in price 308 is transmitted from the user's computing device 102 to buy-in module 110. In some embodiments, buy-in module 110 will debit the user's account in user account module 116 for the amount of the current buy-in price 308 when the signal indicative of the buy-in request is received, in other embodiments, buy-in module 110 will wait to debit the user's account until the auction period is initiated.

It is to be appreciated that, as stated above, to enter a bid in an auction hosted on auction module 124, a user is required to buy in to that action (e.g., via selecting button 314) and the auction period must be initiated. In one embodiment, the user selects bid button 316 to enter a bid in an auction after the auction period is initiated. Upon selecting bid button 316, a signal indicative of a bid request is transmitted from the user's computing device 102 to bid module 108. To ensure, the user has bought into the auction at the current buy-in price, when bid module 108 receives the signal indicative of the user's bid request, bid module 108 is configured to determine if a buy-in was received from the user. In one embodiment, the bid module 108 determines if a buy-in has been received from the user by checking a database including all received user buy-ins. The database including the user buy-ins may be stored and maintained by any one of, or a combination of, buy-in module 110, user account module 116, and/or memory 136. If bid module 108 determines that the user has bought into the auction, bid module 108 will enable or allow the user to enter a bid into the auction. In one embodiment, if bid module 108 enables a user to bid enter a bid in the auction, the user will be prompted by GUI 300 to enter a bid amount the user desires to bid. In another embodiment, where the rules of the auction require fixed bid increments, if bid module 110 enables the user to enter a bid into the auction, when the user selects bid button 316, bid module 108 is configured to enter a bid on the user's behalf that increases the current bid 310 by the bid increment 312.

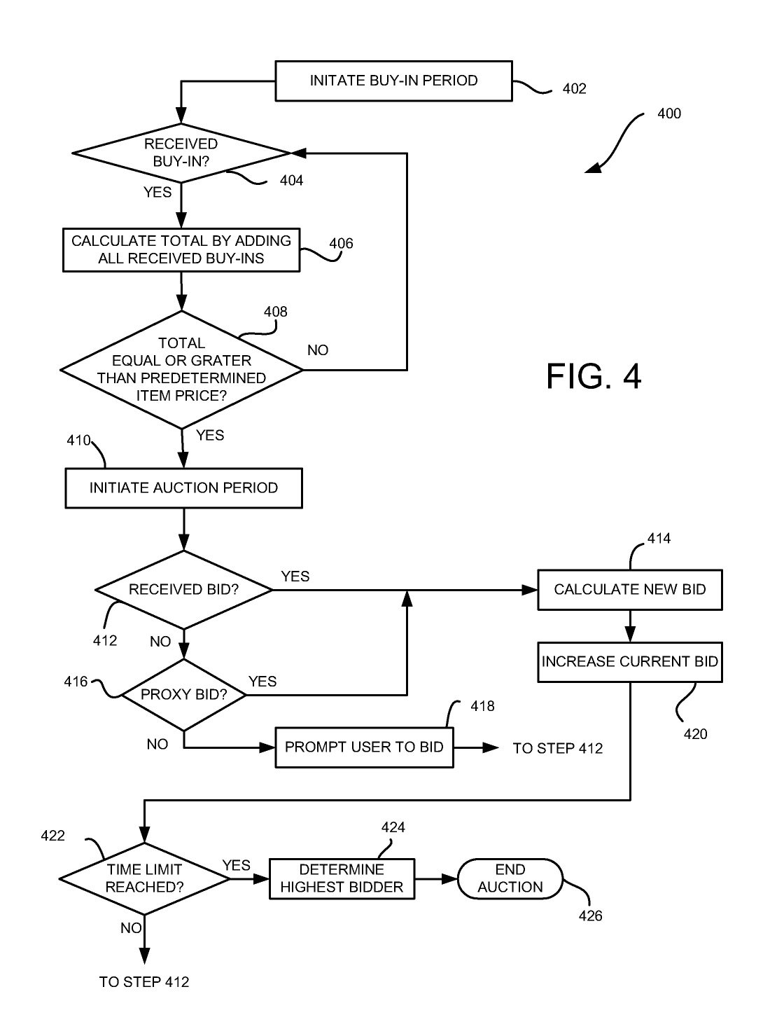

Referring now to FIG. 4 an exemplary method 400 is shown for conducting an online buy-in auction using online-buy in auction server 106 in accordance with the present disclosure. In step 402, after an item is listed on listings module 112 by a seller, auction module 124 is configured to generate and host an auction for the item and initiate a buy-in period. In step, 404, buy-in module 110 waits to receive one or more buy-ins (i.e., buy-in signals) via users desired to participate in an auction for the item. If after each buy-in is received, buy-in module 110 is configured to add all of the received buy-ins to the total amount of money generated from all of the buy-ins received, in step 406. In step 408, buy-in module 110 is configured to determine if the total calculated in step 406 is equal to or greater than a predetermined item price (e.g., set by the seller), in step 408. If, buy-in module 110 determines the total calculated in step 406 is not greater than or equal to the predetermined item price, in step 408, buy-in module is configured to wait to receive additional buy-ins, in step 404. If, buy-in module 110 determines the total calculated in step 406 is equal to or greater than the predetermined item price, in step 408, auction module 124 is configured to initiate the auction period for the auction.

It is to be appreciated that, although not shown, in some embodiments, the buy-in period is a finite amount of time (selected by the user or automatically selected by buy-in module 110). In this embodiment, if the buy-in period expires before the total calculated in step 406 reaches an amount equal to or greater than the predetermined item price, the auction will expire and be removed from auction module 124.

After the auction period for the auction is initiated, live online bidding is permitted for the auction, where users may submit bids for the auction item via bid module 108. In step 412, bid module 108 determines if a bid for the auction item has been received. As described above, it is to be appreciated that the bid amount associated with a received bid may be a fixed amount (i.e., a fixed increment above the previous bid) or an amount chosen by the user. Also, as described above, bid module 108 is configured to only enable a user to enter a bid in an auction, if the user has already bought into the auction. If it is determined by bid module 108 that the bid has been received, in step 412, bid module 108 then calculates the new bid amount 108 (i.e., based on the fixed increment or the amount chosen by the user), in step 414, and the method 400 proceeds to step 420, described below.

If bid module 108 determines that the bid has not been received, in step 412, bid module 108 checks the user's account in module 116 to determine if the user designated proxy bidding rules that require a bid to be placed currently, in step 416. If it is determined by bid module 108 that the proxy bidding rules of the user do not require a bid to be placed currently (or that the user has not designated any proxy bidding rules), in step 416, bid module 108 will prompt the user to place a bid, in step 418, and bid module 108 will continue to wait to receive a bid, in step 412. It is to be appreciated that the prompt may be sent to the user via communication module 118 and Internet 104 or by other means in accordance with the present disclosure.

Alternatively, if bid module 108 determines, based on the proxy bidding rules chosen by the user and stored in the user's account in module 116, that a proxy bid should be placed, in step 416, bid module 108 will calculate the new bid to be placed based on the user's proxy bidding rules, in step 414. In step 420, bid module 108 will increase the bid amount to be the new bid calculated in step 414.

In step 422, time limit module 114 determines if time limit module 114 determines that a time limit associated with the auction period has been reached (i.e., if the time to bid on the item expired). If time limit module 114 determines that the time limit has not been reached, in step 422, the method 400 returns to step 412, where bid module 108 waits to receive another bid. If time limit module 114 determines that the time limit has been reached, in step 422, bid module 108 will determine which user placed the last and highest bid of all of the bids received to determine a winner of the auction, in step 424, and the auction will end, in step 426.

After the end of the auction, the account in account module 116 of the user who placed the highest bid will be debited (by controller 120 and/or bid module 108) for the winning bid amount or price. Furthermore, the accounts of all of the participants of the auction will be debited for the buy-in amount or price. The account of the selling user will be credited with the total of all of the buy-ins and with the winning bid amount. Bid module 108 will also send a signal to the winning user's computing device 102 via communication interface 118 indicating the user is the winner of the auction. GUI 122 will then remove the auction that has ended from table 204.

Although not shown in method 400, in some embodiments, buy-in module 110 may be configured to lower the buy-in amount (by a fixed amount or an amount dynamically determined by buy-in module 110) for each buy-in received after step 410, where the auction period is initiated. Furthermore, the buy-in amount may be adjusted dynamically and automatically by buy-in module 110 based on one or more factors described above during either the buy-in period and/or the auction period of an auction.

In some embodiments, selling users are required (e.g., by controller 120 or listing module 112) to select the predetermined item price for an item, such that, when the predetermined item price is reached or exceeded by the total amount of buy-ins received shipping and/or return costs for the item are covered by the proceeds of the buy-in. For example, after a selling user has selected the predetermined item price for an item, the price may be automatically increased by controller 120 or listing module 112 to allot for shipping and/or return costs.

The online buy-in auction system 100 of the present disclosure provides many technological improvements over other existing online auction systems.

For example, existing online auction systems suffer from dishonest seller activity. For example, in traditional online auctions systems, “shill bidding” may occur, where a seller bids on his own item to drive up the bid price, or asks a third party to bid on their item to drive up the bid price. Since, in traditional online auctions, the winning bidder is the only participant that is required to pay, as long as the seller or a member of his/her third party “shill bidder” do not have the winning bid, there is no safeguard against “shill bidding”. The online buy-in auction system of the present disclosure, disincentivizes “shill bidding” because each user must submit the buy-in price to later participate in the auction. If an auction period is triggered, the buy-in submitted is non-refundable. Therefore, since the buy-in is non-refundable after the auction period has been initiated, only serious bidders will be enticed to enter the auction. Also, since, as described above, in an auction conducted using system 100 of the present disclosure, even before the auction period for auction 126 has been initiated, the seller has already been guaranteed to generate enough money to pay for the predetermined item price, which is chosen by the seller, the seller is less likely to partake in “shill bidding”, since the seller has already made a minimum amount of money via the buy-ins submitted even before bidding has begun.

As another example of an improvement over traditional online auction systems, system 100 of the present disclosure disincentivizes “nuclear bidding”, which regularly occurs on traditional online buy-in auction systems. “Nuclear bidding” occurs when a buyer places outrageously high bids in an auction without intending to pay at the end of an auction. This practice is disincentivized by system 100 of the present disclosure since, once an auction period is triggered, the user account of each user having submitted a buy-in is automatically debited for the buy-in amount and the buy-in amount is non-refundable. Since the buy-in amount is non-refundable, each user participating in the auction will have an incentive to keep the price low enough so as to avoid unnecessarily losing the buy-in amount that is non-refundable and paying high bidding amounts in addition to the buy-in amount already paid.

The buy-in auction format of the present disclosure also leads to lower bid prices than traditional online auction formats, since both “shill bidding” and “nuclear bidding” is less likely to occur.

The online buy-in auction system and format of the present disclosure also provides advantages over traditional online auctions in the return process. Since, as described above, the shipping and/or return fees may be priced into the predetermined item price chosen by the seller, shipping and/or returns are free for the winning buyer. Furthermore, since an item is only sold in an auction after the seller is guaranteed to have made back the predetermined item price via the total number of buy-ins received, and since the buy-ins are not refundable after the auction period has commenced, even if a buyer returns an item, the seller is not at risk of losing money by having to resell an item that may even have potentially been damaged by the winner buyer in the return process. Since the buy-ins are non-refundable after the auction period has commenced, a seller is protected from fraudulent and dishonest buyer practices (such as unwarranted and/or delayed returns of a sold item or “wardrobing”, where an item is purchased via online auction and worn for one day or very few days and then returned for a full refund).

Also, the online buy-in auction system of the present disclosure also provides technological advantages over traditional online auction websites in that the present disclosure provides for the automatic and dynamic adjustment of the buy-in price by buy-in module 110, described above. Because buy-in module 110 is configured to automatically and dynamically adjust the buy-in price of an auction, the buy-in may continuously be adjusted to entice more buyers and lock in more buy-ins for the seller. Furthermore, as is the case with price-capped auctions described above, the automatic and dynamic adjustment of the buy-in price leads to lower overall prices for the buyers participating in an auction on system 100 of the present disclosure.

It is to be appreciated that the various features shown and described are interchangeable, that is a feature shown in one embodiment may be incorporated into another embodiment.

While non-limiting embodiments are disclosed herein, many variations are possible which remain within the concept and scope of the present disclosure. Such variations would become clear to one of ordinary skill in the art after inspection of the specification, drawings and claims herein. The present disclosure therefore is not to be restricted except within the spirit and scope of the appended claims.

Furthermore, although the foregoing text sets forth a detailed description of numerous embodiments, it should be understood that the legal scope of the present disclosure is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

What is claimed is:

1. An apparatus, comprising:
a communication module coupled to a network, the communication module configured to send and receive communications over the network;
an auction module configured to host at least one online auction for at least one item, the at least one item having a predetermined item price;
a buy-in module configured to:
receive a plurality of buy-ins via the communication module, each buy-in associated with a user and being of a predetermined amount,
determine a total amount by adding the plurality of buy-ins,
determine if the total amount is equal to or greater than the predetermined item price,
wherein if it is determined that the total amount is equal to or greater than the predetermined item price, the auction module is configured initiate an auction period for the at least one online auction; and
a bid module configured to:
enable each user having submitted a buy-in for the predetermined amount for the at least one online auction to submit at least one bid for the at least one item if the auction period is initiated,
receive a plurality of bids via the communication module for the at least one item,
determine a highest bid of the plurality of bids received, and
determine a winner of the at least one auction, the winner having placed the highest bid within the auction period.

2. The apparatus of claim 1, wherein, for each buy-in received after the auction period is initiated, the bid module is configured to reduce the predetermined amount.

3. The apparatus of claim 2, wherein, each time the predetermined amount is reduced, the buy-in module is configured to refund each user having submitted a buy-in for the predetermined amount based on an amount the predetermined amount was reduced by.

4. The apparatus of claim 1, wherein the buy-in module is configured to dynamically adjust the predetermined amount based on at least one factor.

5. The apparatus of claim 4, wherein the at least one factor is a time elapsed from the last received buy-in.

6. The apparatus of claim 4, wherein the at least one factor is a rate at which the plurality of buy-ins are being received.

7. The apparatus of claim 6, wherein the at least one fact is whether the rate at which the plurality of buy-ins are being received is increasing or decreasing.

8. The apparatus of claim 4, wherein the at least one factor is the amount of time left in the auction period.

9. The apparatus of claim 8, further comprising a user account module configured to store proxy bidding rules for at least one user, wherein the bid module is configured to automatically enter at least one bid in the at least one auction during the auction period on the at least one user's behalf based on the proxy bidding rules stored in the user account module.

10. The apparatus of claim 1, wherein the auction module is configured to transmit a notification via the communication module to each of the users having submitted a buy-in for the predetermined amount for the at least one online auction when the auction period is initiated, the notification indicative of the initiation of the auction period.

11. A method, comprising:
hosting, by an auction module, at least one online auction for at least one item, the at least one item having a predetermined item price;
receiving, by a buy-in module, a plurality of buy-ins, each buy-in associated with a user and being of a predetermined amount;
determining, by the buy-in module, a total amount by adding the plurality of buy-ins, and
determining, by the buy-in module, if the total amount is equal to or greater than the predetermined item price, wherein if it is determined that the total amount is equal to or greater than the predetermined item price, the auction module is configured initiate an auction period for the at least one online auction,
enabling, by a bid module, each user having submitted a buy-in for the predetermined amount for the at least one online auction to submit a bid for the at least one item if the auction period is initiated;
receiving, by the bid module, a plurality of bids for the at least one item;
determining, by the bid module, a highest bid of the plurality of bids received; and
determining, by the bid module, a winner of the at least one auction, the winner having placed the highest bid within the auction period.

12. The method of claim 11, further comprising:
reducing, by the buy-in module, the predetermined amount for each buy-in received after the auction period is initiated.

13. The method of claim 12, further comprising: refunding, by the buy-in module, each user having submitted a buy-in for the predetermined amount based on an amount the predetermined amount was reduce by each time the predetermined amount is lowered.

14. The method of claim 11, further comprising: dynamically adjusting, by the buy-in module, the predetermined amount based on at least one factor.

15. The method of claim 14, wherein the at least one factor is a time elapsed from the last received buy-in.

16. The method of claim 14, wherein the at least one factor is a rate at which the plurality of buy-ins are being received.

17. The method of claim 16, wherein the at least one fact is whether the rate at which the plurality of buy-ins are being received is increasing or decreasing.

18. The method of claim 14, wherein the at least one factor is the amount of time left in the auction period.

19. The method of claim 18, further comprising: automatically entering, by the bid module, at least one bid in the at least one auction on the at least one user's behalf based on proxy bidding rules associated with the at least one user and stored in a user account module.

20. The method of claim 1, further comprising: transmitting, via a communication module, a notification to each of the users having submitted a buy-in for the predetermined amount for the at least one online auction when the auction period is initiated, the notification indicative of the initiation of the auction period.
